(19) United States
(12) Patent Application Publication
(10) Pub. No.: US 2015/0299971 A1
(43) Pub. Date: Oct. 22, 2015

(54) RADIANT HEATING SYSTEM AND METHOD FOR VEHICLE MOUNTED SALT BOX

(71) Applicant: Gregory Carpenter, Clarksville, MD (US)

(72) Inventor: Gregory Carpenter, Clarksville, MD (US)

(21) Appl. No.: 14/617,157

(22) Filed: Feb. 9, 2015

Related U.S. Application Data
(60) Provisional application No. 61/937,002, filed on Feb. 7, 2014.

(51) Int. Cl. E01H 10/00; B60H 1/06

(52) U.S. Cl. CPC E01H 10/007; B60H 1/06

(57) ABSTRACT

Disclosed is a system and method for radiant heating in a vehicle-mounted salt box in which heated coolant from the engine on which the salt box is mounted is routed to a radiant heating coil within the salt box to warm the salt, thus preventing the creation of frozen clumps of salt in the salt box, while minimizing the expense required to supply such heat to the salt through use of the vehicle's own existing engine cooling system. The radiant heating coil is particularly configured to closely match the contour of a portion of the salt box hopper to maximize heat transfer between the heat transfer fluid and the salt, and preferably the salt box hopper itself.

### CROSS-REFERENCE TO RELATED APPLICATION

This application is based upon and claims benefit of copending U.S. Provisional Patent Application Ser. No. 61/937,002 entitled “Radiant Heating System and Method for Vehicle Mounted Salt Box,” filed with the U.S. Patent and Trademark Office on Feb. 7, 2014 by the inventor herein, the specification of which is incorporated herein by reference in its entirety.

### FIELD OF THE INVENTION

The present invention relates generally to systems and methods for treating and/or de-icing road surfaces, and more particularly to a retrofit system and method for heating salt in a vehicle-mounted salt box using the vehicle's existing engine coolant system.

### BACKGROUND

Winter weather creates hazardous road conditions as precipitation freezes on road surfaces, causing ice patches that, when encountered by an unaware or unprepared driver, can cause costly accidents and injuries. In order to reduce the risk of such ice patches forming, it has long been a practice of contractors and municipalities to apply a treatment agent to the road surface that helps to melt any ice that forms on the road surface. The most common agent for such purposes has been salt, which is a generally plentiful resource and avoids costly manufacture using synthetic materials, and for which there are a wide variety of readily available devices for storing sufficient quantities of salt on a vehicle and distributing the salt from such vehicle.

FIG. 1a shows an exemplary vehicle-mounted device for carrying a deicing agent, such as salt, and distributing such agent from the vehicle as the vehicle travels along the road. A hopper 100 is provided on the back of a vehicle 10. By way of non-limiting example, vehicle 10 may comprise a pickup truck with a rear flatbed 12 on which hopper 100 may be situated. Alternatively, hopper 100 may be, again by way of non-limiting example, mounted to a frame of larger, heavy duty truck. In each case, the typical configuration provides a bottom support for the hopper 100 (in the examples above, either the flatbed 12 or the truck frame), with the hopper 100 positioned so that a salt distributor 20 attached to the back end of the hopper 100 may hang downward from the body of vehicle 10 toward the road surface. Such salt distributors 20 may be provided in a wide variety of configurations that are well known to those of ordinary skill in the art, and are thus not further detailed here.

FIG. 2 shows the interior of a typical vehicle-mounted hopper 100 as used in the system of FIG. 1, which again is used for holding salt that is to be distributed on a road surface. Such hoppers are generally referred to as “salt boxes,” the configuration of which is again well known to those of ordinary skill in the art. As shown in FIG. 2, the salt box has sidewalls 102 that angle inward at their lower ends toward a base 104, and the base itself slants toward a centrally located salt conveyor 106 mounted below hopper 100 which conveys salt to a salt distributor 20 (FIG. 1) on the back, exterior of the hopper 100. An outlet 108 is typically provided at the lowest point of the exit channel of the hopper 100, which outlet 108 delivers salt to salt conveyor 106 and onward to a salt distributor 20.

While salt is often a preferred de-icing agent (given its wide availability), it does tend to, over time and in very cold conditions, form frozen blocks or chunks that can block the outlet 108, thus stopping distribution until the operator has an opportunity to unclog the system and break up the solidified blocks of salt. It would therefore be advantageous to heat the salt in the salt box 100 in order to prevent such frozen blocks or chunks from forming.

While efforts have previously been made to heat chemicals intended for use as de-icing agents on roadways, they have typically required costly, heavy heating equipment (e.g., separate butane heaters) and heat fuel sources, thus limiting their commercial acceptance. Thus, it would also be advantageous to provide a system that could heat the salt in the salt box 100 without requiring the addition of such costly and heavy heating equipment.

### SUMMARY OF THE INVENTION

Disclosed is a system and method for radiant heating in a vehicle-mounted salt box in which heated coolant from the engine on which the salt box is mounted is routed to a radiant heating coil within the salt box to warm the salt, thus preventing the creation of frozen clumps of salt in the salt box, while minimizing the expense required to supply such heat to the salt through use of the vehicle's own existing engine cooling system. The radiant heating coil is particularly configured to closely match the contour of a portion of the hopper to maximize heat transfer between the heat transfer fluid and the salt, and preferably the hopper itself.

In accordance with certain aspects of an embodiment of the invention, a radiant heating system configured for use with a vehicle-mounted material hopper is provided, comprising: a radiant heating coil comprising an inlet line, an outlet line, a first bottom side section extending away from the inlet line and configured to follow the contour of a first interior side edge of a vehicle-mounted material hopper, a second bottom side section extending away from the outlet line and configured to follow the contour of a second interior side edge of the vehicle-mounted material hopper opposite the first interior side edge, and a u-shaped section fluidly connected to and positioned between the first bottom side section and the second bottom side section and configured to extend into a central recess extending longitudinally along a bottom of the vehicle-mounted material hopper; a heat transfer fluid supply line having a first end and a second end, the first end of the fluid supply line being attached to the inlet line and the second end being configured for connection to a hot supply line from a water pump to a heater core on a vehicle on which the vehicle-mounted material hopper is carried; and a heat transfer fluid return line having a first end and a second end, the first end of the fluid return line being attached to the outlet line and the second end being configured for connection to a cold return line from the heater core to the water pump on the vehicle.

In accordance with further aspects of an embodiment of the invention, a vehicle-mounted radiant heating system is provided, comprising: a material hopper mounted to a vehicle; a radiant heating coil positioned within an interior of the material hopper, the radiant heating coil comprising an inlet, an outlet, and a flow section between the inlet and the outlet configured to radiate heat to material within the material hopper; a heat transfer fluid supply line having a first end and a second end, the first end of the fluid supply line being attached to the inlet; and a heat transfer fluid return line having a first end and a second end, the first end of the return line being attached to the outlet; wherein the second end of the fluid supply line and the second end of the fluid return line are each attached to and in fluid communication with an engine coolant flow system on the vehicle.

In accordance with still further aspects of an embodiment of the invention, a method for retrofitting a vehicle-mounted material hopper with a radiant heating system is provided, comprising: providing a radiant heating coil comprising an inlet, an outlet, and a flow section between the inlet and the outlet configured to radiate heat to material within a material hopper mounted on a vehicle; positioning the radiant heating coil inside of and along a bottom surface of the material hopper; attaching a first end of a heat transfer fluid supply line to the inlet, and a second end of the heat transfer fluid supply line to an engine coolant flow system on the vehicle; and attaching a first end of a heat transfer fluid return line to the outlet, and a second end of the heat transfer fluid return line to the engine coolant flow system.

### BRIEF DESCRIPTION OF THE DRAWINGS

The numerous advantages of the present invention may be better understood by those skilled in the art by reference to the accompanying drawings in which:

FIG. 1a is a perspective view of a prior art vehicle-mounted salt box.

FIG. 1b is a perspective view of a radiant heating system installed in a vehicle-mounted salt box in accordance with aspects of an embodiment of the invention.

FIG. 2 is a perspective view of the interior of the prior art salt box of FIG. 1a.

FIG. 3 is a perspective view of the interior of the salt box of FIG. 1b.

FIG. 4a is a front perspective view of a radiant heating coil for use with the system of FIG. 1b.

FIG. 4b is a side perspective view of the radiant heating coil of FIG. 4a.

FIG. 5 is a side view of a fluid connection for use with the system of FIG. 1b at the vehicle-mounted salt box.

FIG. 6a is perspective view of a fluid connection for use with the system of FIG. 1b at the vehicle's engine coolant fluid system.

FIG. 6b is a close-up perspective view of the fluid connection of FIG. 6a.

FIG. 7 is a top view of a portion of a flat bed of the vehicle of FIG. 1b showing a portion of a fluid transfer system for use with the system of FIG. 1b.

FIG. 8 is a schematic flow chart representing a radiant heating method for a vehicle-carried salt box in accordance with further aspects of an embodiment of the invention.

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

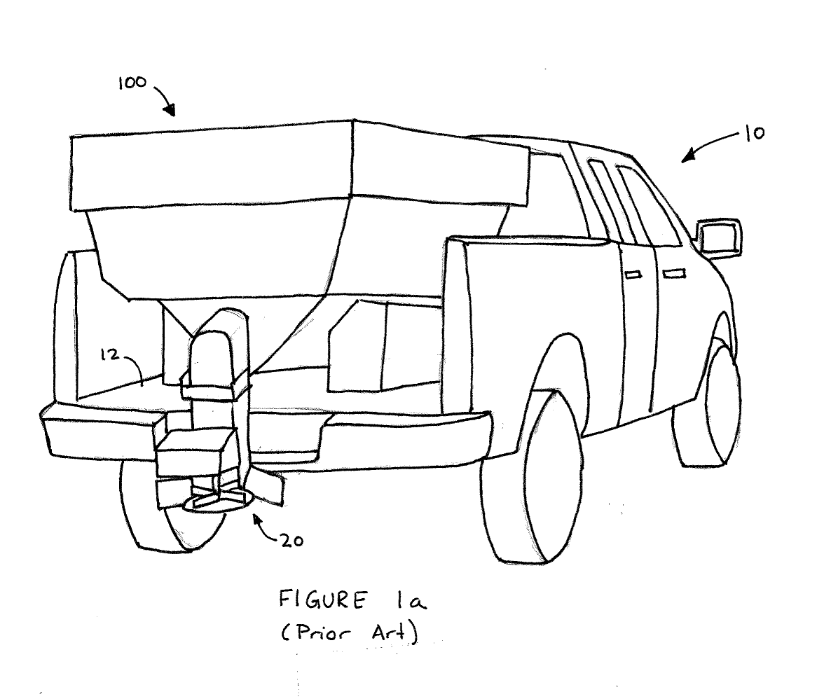

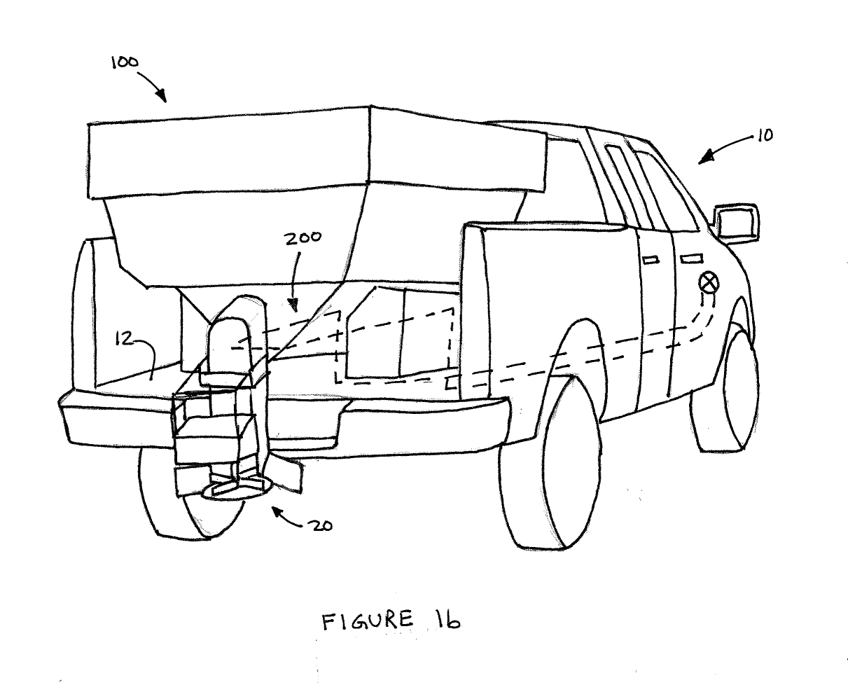

In accordance with certain aspects of an embodiment of the invention, and with reference to FIG. 1b, a vehicle-mounted salt distribution system is disclosed that includes a radiant heating coil 200 in hopper 100 for heating the salt in the hopper and preventing it from freezing and clogging the distribution system. The radiant heating coil is integrated with the existing engine coolant system of a vehicle 10 on which the hopper 100 is carried, and thus is able to heat the salt in the hopper without requiring the integration of external heater devices. The system may be provided as a kit that may be retrofit onto the vehicle through simple adjustment of the vehicle's coolant system, thus rendering the system widely and easily applicable to salt distribution systems that are already in use.

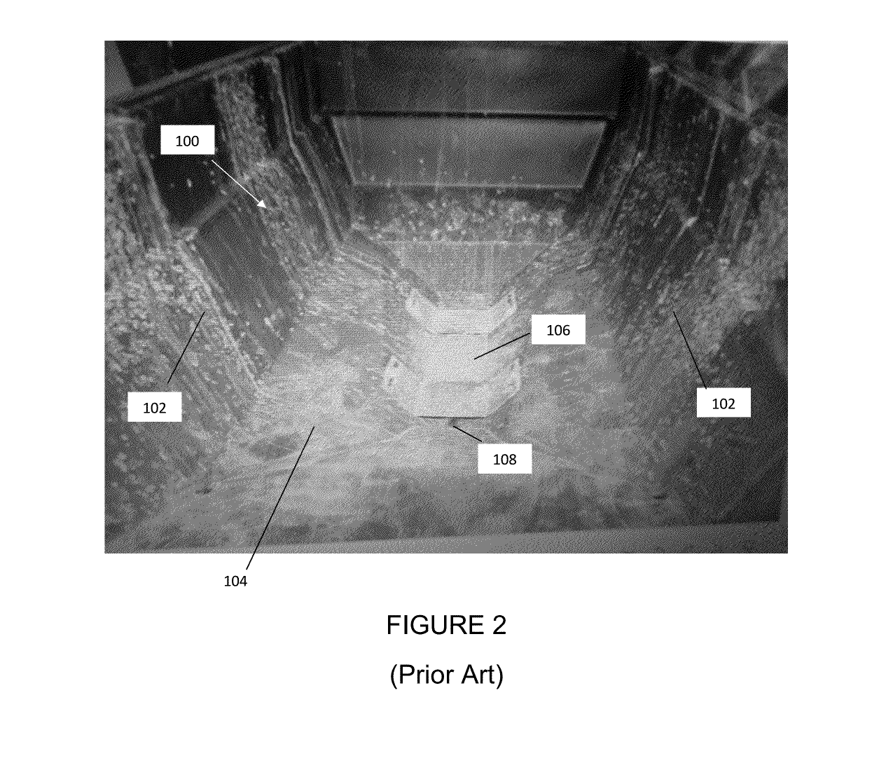

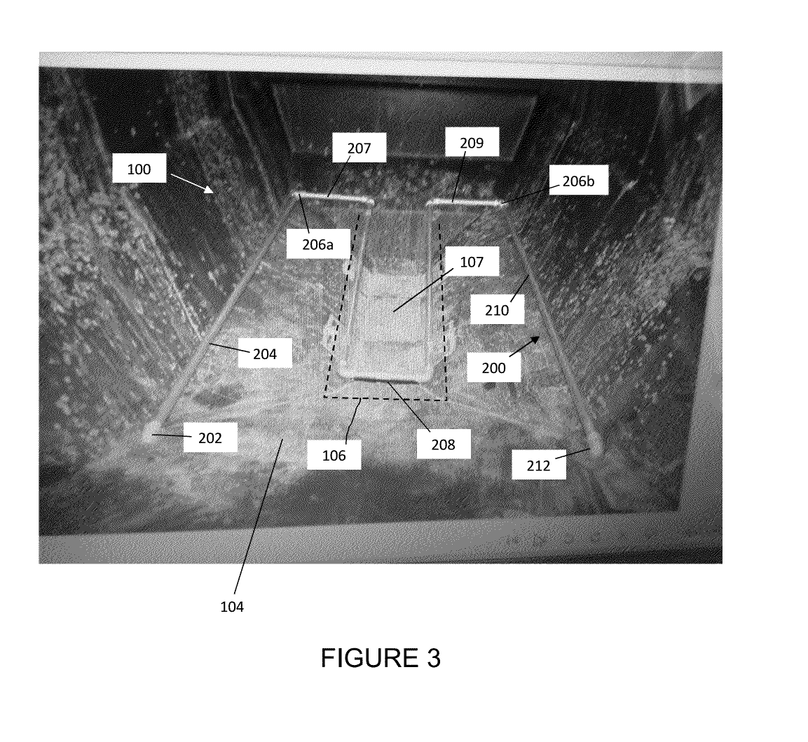

FIGS. 1b and 3 show the hopper 100 of FIGS. 1a and 2 having been retrofitted with a radiant heating coil 200 carrying a heated heat transfer fluid (and more particularly heated engine coolant as discussed in greater detail below). The radiant heating coil 200 preferably enters the hopper through an opening 202 in the base of the hopper, and particularly at one corner of the base of the hopper. The radiant heating coil then runs generally along a first bottom side section 204 and, at the next corner 206a, turns in along first rear section 207 toward a longitudinally extending recess 107 in a central portion of the base of hopper 100, which longitudinally extending recess 107 forms the lowermost portion of the interior of hopper 100, and aligns with the salt conveyor 106 positioned below hopper 100. As radiant heating coil 200 extends along the first bottom side section 204, it is preferably in contact with the interior surface of hopper 100 (and thus closely follows the contour of the interior, bottom edges of hopper 100), such that heat may be transferred from a heat transfer fluid within radiant heating coil 200 to the body of hopper 100.

The radiant heating coil 200 includes a downwardly angled, u-shaped section 208 extending into recess 107 so as to preferably be in contact with three sides of the recess 107 to further aid in heat transfer from the heat transfer fluid within coil 200 to the hopper 100 and to material stored in hopper 100, particular at the point at which it is dispensed from hopper 100. Moreover, u-shaped section 208 slopes vertically downward along a gradual slope into recess 107 as it extends from the open end of u-shaped section 208 (i.e., where it attaches to first rear section 207 and a second rear section 209 of coil 200) toward the closed end of u-shaped section 208. At second rear section 209, radiant heating coil 200 turns from u-shaped section 208 toward a second bottom side section 210 of coil 200, and turns at corner 206b into second bottom side section 210 of coil 200. As coil 200 extends along second bottom side section 210, it is preferably again in contact with the interior surface of hopper 100 (and thus closely follows the contour of the interior bottom edge of hopper 100), such that heating may be transferred from the heat transfer fluid within radiant heating coil 200 to the body of hopper 100. Second bottom side section 210 of coil 200 extends from corner 206b to an outlet 212 at the opposite corner from the inlet 202.

In certain configurations, heating coil 200 may be formed of a plastic pipe, and more particularly a schedule 80 plastic pipe, which allows sufficient heat transfer between the heat transfer fluid carried in the coil 200 and the material within hopper 100, without causing such excessive localized heating around coil 200 that will melt and fuse such material to coil 200. However, alternative materials could be used without departing from the spirit and scope of the invention, such as metal tubing and a temperature regulator preventing the temperature of the heat transfer fluid from being so high that the metal coil might tend to melt the salt or other material in hopper 100 immediately surrounding coil 100.

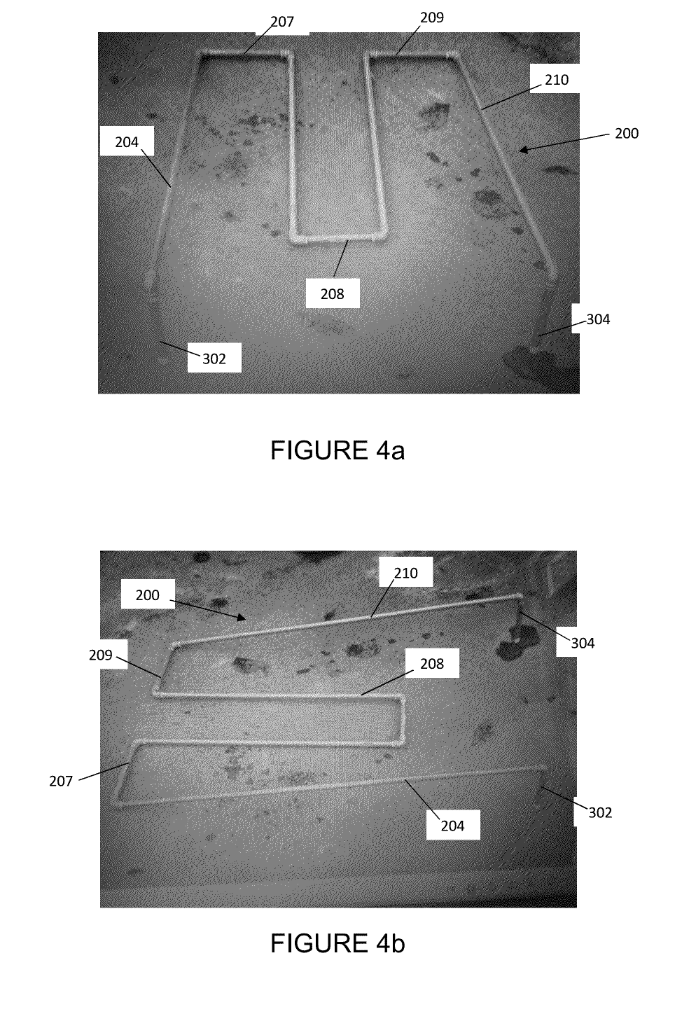

With continued reference to FIG. 3, along with the front perspective view of the radiant heating coil 200 of FIG. 4a and the side perspective view of the radiant heating coil 200 of FIG. 4b, the radiant heating coil 200 forms a general zig-zag pattern across the base of the salt box, which zig-zag pattern distributes heat so as to prevent the salt from freezing and forming blocks or chunks in the area around the salt box outlet. The radiant heating coil 200 radiates heat to the salt within the salt box 100, and likewise preferably radiates heat to the salt box structure itself so as to warm the hopper 100 overall, further warming the salt that is situated further away from the radiant heating coil 200 and lowering the overall tendency of the salt to freeze up and form blocks.

In order to closely fit within the interior of hopper 100, and with particular reference to FIG. 4b, coil 200 is configured (as referenced above) so that interior u-shaped portion 208 has a generally downward slope in relation to each of first bottom side section 204 of coil 200 and second bottom side section 210 of coil 200. Further, first rear section 207 may optionally bend slightly downward from first bottom side section 204 as it approaches the open end of u-shaped portion 208, and second rear section 209 may likewise optionally bend slightly downward from second bottom side section 210 as it approaches the open end of u-shaped portion 208, in each case to closely follow the interior contour of the bottom edges of hopper 100.

Those of ordinary skill in the art will recognize that the particular zig-zag profile of the radiant heating coil 200 may be modified for varying salt box configurations, including by providing additional bends and back-and-forth runs, to properly configure the radiant heating coil 200 to evenly distribute heat to the salt in the hopper 100.

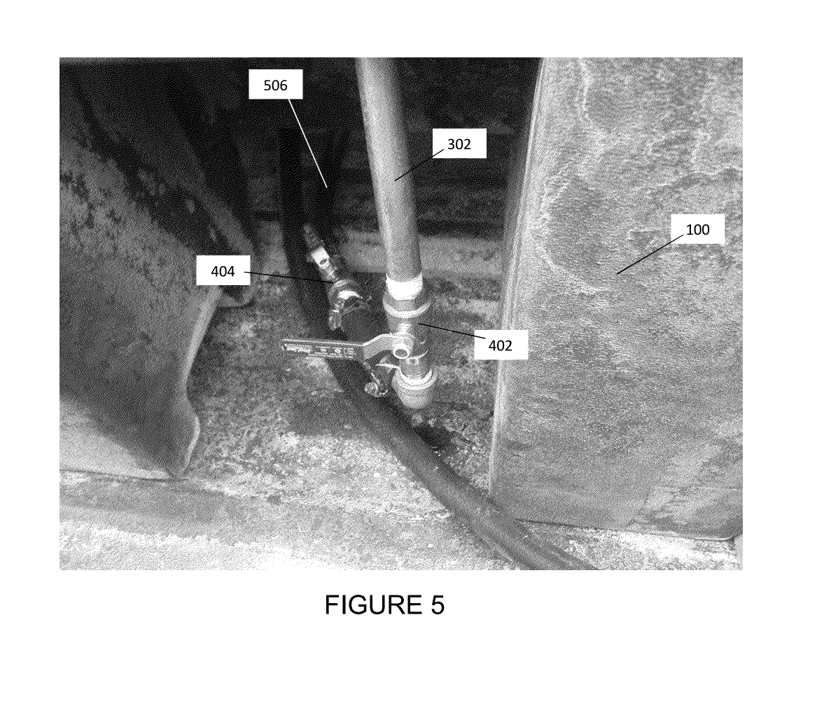

FIG. 5 shows a connection suitable for connecting heat transfer fluid supply and return hoses to the radiant heating coil 200. Preferably, those connections each include the connection shown in FIG. 5, and more particularly a flow control assembly (such as manually adjustable valves 402, 404) to control the heat transfer fluid flow rate at the supply and return ends of the radiant heating coil 200. In the configuration of FIG. 5, a heating coil inlet line in the form of riser 302 of heating coil 200 is shown extending upward, which ultimately enters into salt box 100 through inlet 202. As best seen in FIGS. 4a and 4b, riser 302 is a generally vertical section of heating coil 200 that is configured to extend through the bottom of hopper 100 at the inlet end of heating coil 200. Likewise, a heating coil outlet line in the form of riser 304 is a generally vertical section of heating coil 200 that is configured to extend through the bottom of hopper 100 at the outlet end of heating coil 200. Each of risers 302 and 304 is of sufficient length so as to allow a worker to easily access the fluid inlet and outlet points of heating coil 200 for aiding in installation, removal, and service. Also, as best viewed in FIG. 4b, first bottom side section 204 of heating coil 200 preferably extends away from inlet riser 302 at an angle of greater than 90°, and second bottom side section 210 of heating coil 200 preferably extends away from inlet riser 304 at an angle of greater than 90°, so that as each of risers 302 and 304 are positioned vertically, first bottom side section 204 and second bottom side section 210 extend at a downward angle to follow the downwardly sloping interior bottom surface of hopper 100.

Preferably, a quick connect coupler of standard configuration known to those of ordinary skill in the art is provided to join the supply and return hoses to the radiant heating coil 200, and may be positioned between valves 402, 404 to allow easy fluid shut-off when a connection is to be made or disconnected. A heat transfer fluid supply line 506 connects at one end to heating coil 200 (e.g., through valves 402 and 404), and connects at another end to the coolant flow system of the vehicle on which the system is installed, as discussed in greater detail below.

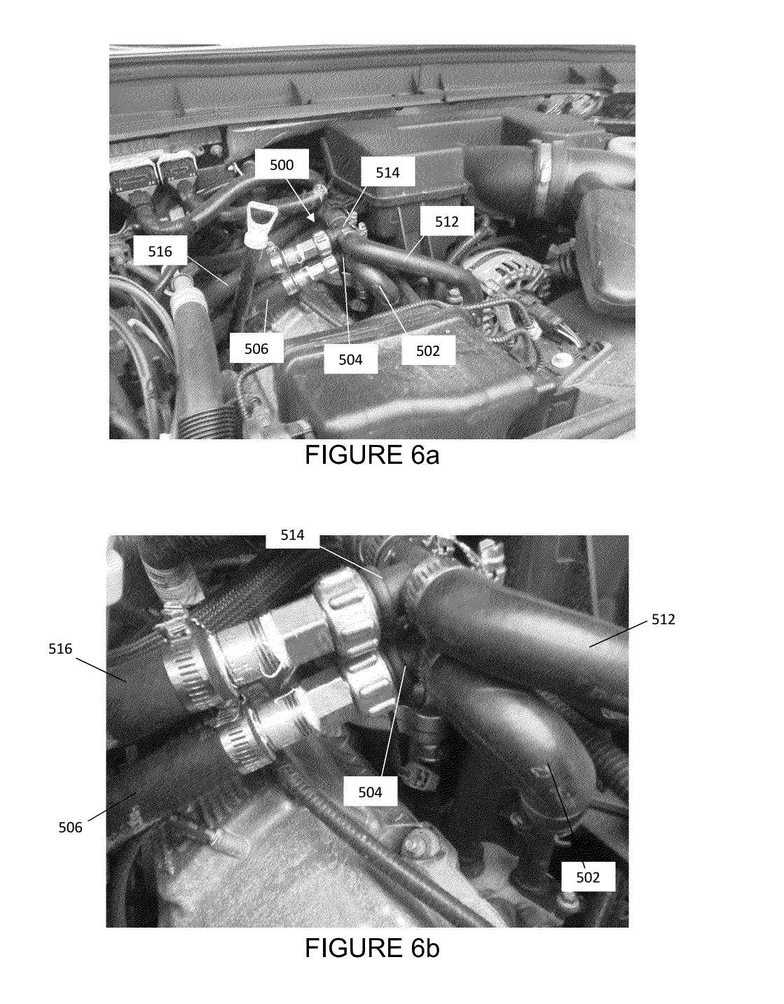

FIGS. 6a and 6b show the engine compartment of the vehicle on which the salt box is mounted, with a simple retrofit connection (shown generally at 500) into the vehicle's existing engine coolant system to supply heat transfer fluid, and more particularly the existing engine coolant, to the radiant heating coil and to return it to the engine coolant system after it has passed through the radiant heating coil in the hopper 100. As shown in FIGS. 6a and 6b, the hot supply line 502 from the vehicle's water pump to the vehicle's heater core is intercepted by inserting a T-section 504 into such hot supply line, which directs a portion of the heated engine coolant through a supply line 506 to the radiant heating coil 200. Likewise, the cold return line 512 from the heater core back to the water pump is intercepted by inserting a second T-section 514 into such cold return line, which receives the engine coolant that has passed through the radiant heating coil and through a radiant heating coil return line 516, and directs the same back into the cold return line 512 from the heater core. FIG. 6b shows a close-up view of such retrofit connections. With this adaptation, the vehicle's existing engine coolant system is used to direct heated fluid to the radiant heating coil 200 without negatively impacting vehicle engine performance, and thus avoiding the need to integrate on the vehicle costly and heavy separate heating sources and heat fuel sources.

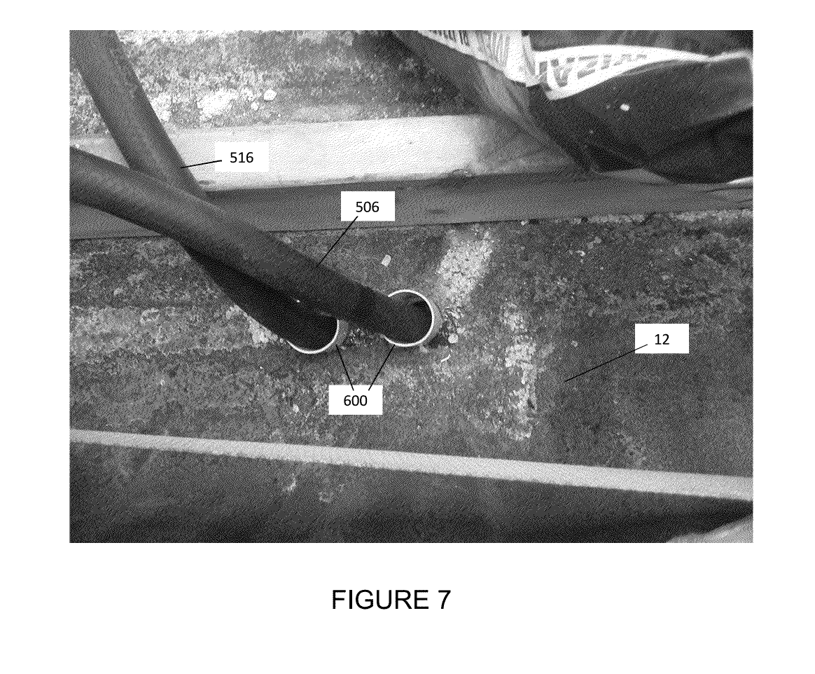

As shown in FIG. 7, both the radiant heating coil supply line 506 and the radiant heating coil return line 516 must be routed from the vehicle's engine compartment back to the hopper 100, which may be positioned within the bed 12 of a truck. In order to protect those lines from premature wear or damage, cylindrical sleeves 600 (e.g., PVC tubing) may be inserted in holes cut into the bed surface at a suitable location for the supply and return lines to pass through.

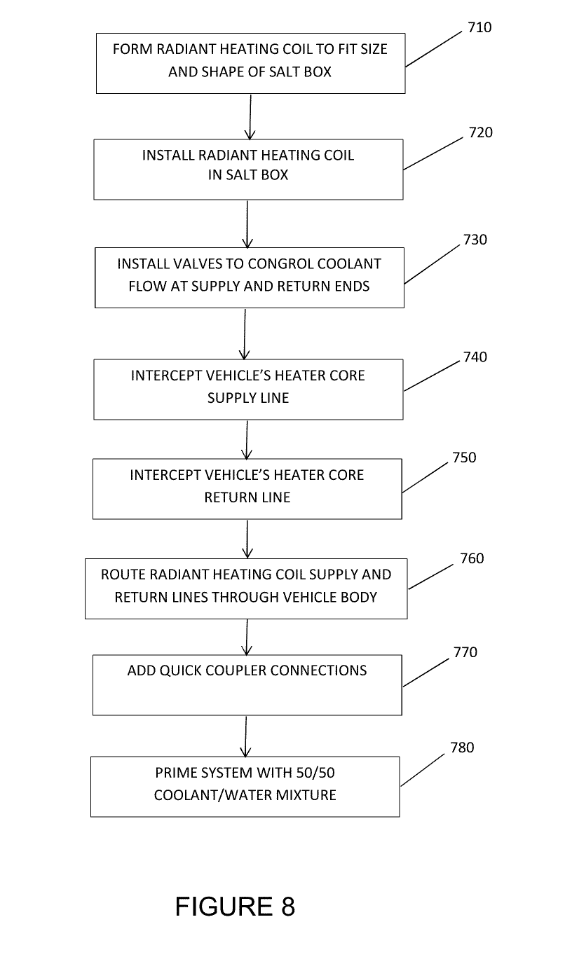

A method of retrofitting a vehicle-mounted salt delivery system for heating salt (or such other material as may be used by those of ordinary skill in the art) using the vehicle's own engine coolant system is also provided. As shown in the flow chart of FIG. 8, at step 710, the radiant heating coil is formed, such as from plastic pipe, and more particularly a schedule 80 plastic pipe, although other materials may be used as discussed above (such as, by way of non-limiting example, galvanized powder coated steel and a temperature regulator used to limit the temperature within the steel coil), and with a coil size and shape that are customized for the particular size and shape of a salt box hopper, but in any event in such a configuration so as to ensure radiative heat distribution across the full base of the salt box hopper. At step 720, the radiant heat coil is installed in the salt box hopper, preferably with the coil supply and return ends extending through a surface of the salt box hopper. At step 730, valves are installed to control the coolant flow rate at both the supply and return ends of the radiant heating coil, and quick coupler connections are preferably provided at each such supply and return end for connecting to supply and return lines from the vehicle's engine compartment. In order to provide the necessary fluid connections, at step 740 the vehicle's heater core supply line (coming from the vehicle's water pump) is cut and a T-fitting is inserted in that line and joined to the radiant heating coil supply line (which is routed to the rear of the vehicle to reach the radiant heating coil). Similarly, at step 750 the vehicle's heater coil return line (routed to the vehicle's intake manifold) is cut and a second T-fitting is inserted in that line and joined to the radiant heating coil return line (which again is routed to the rear of the vehicle to reach the radiant heating coil). At step 760, both the radiant heating coil supply line and the radiant heating coil return line are fed through sleeves (e.g., PVC tubing) extending through the vehicle body, such as the bed of the vehicle, in order to access the radiant heating coil in the salt box hopper. At step 770, quick coupler connections are added to the ends of each of the radiant heating coil supply line and the radiant heating coil return line. At step 780, a first jumper hose may then be used to join the quick coupler on the radiant heating coil supply line to the quick coupler on the radiant heating coil inlet end, and a second jumper hose may be used to join the quick coupler on the radiant heating coil return line to the quick coupler on the radiant heating coil outlet end. Finally, at step 790 a preferably 50/50 coolant/water mixture is added to the now extended engine coolant system while bleeding air from that system to prime the full length of the system (including the new run extending to, through, and from the radiant heating coil in the salt box hopper).

Optionally, and while not shown in the Figures, additional radiant heating coils may be provided in the hopper 100, separated vertically inside of the hopper 100 (and similarly tied to the existing engine coolant system) so as to provide additional heating to both the hopper 100 and the salt or other material contained therein. Moreover, those of ordinary skill in the art will recognize that additional features or modifications to the system and method described above may readily be made without departing from the spirit and scope of the invention. For example, and as mentioned briefly above, one or more temperature regulators may be provided to regulate the temperature of heat transfer fluid flowing within radiant heating coil 200, in addition to pressure, flow, or other regulators as may become apparent to those of ordinary skill in the art. Moreover, additional quick-connect couplings may be provided at different locations throughout the above-described system to aid in retrofit installation and in placement and removal of the system for temporary salt box installations.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. A radiant heating system configured for use with a vehicle-mounted material hopper, comprising:
a radiant heating coil comprising an inlet line, an outlet line, a first bottom side section extending away from said inlet line and configured to follow the contour of a first interior side edge of a vehicle-mounted material hopper, a second bottom side section extending away from said outlet line and configured to follow the contour of a second interior side edge of said vehicle-mounted material hopper opposite said first interior side edge, and a u-shaped section fluidly connected to and positioned between said first bottom side section and said second bottom side section and configured to extend into a central recess extending longitudinally along a bottom of said vehicle-mounted material hopper;
a heat transfer fluid supply line having a first end and a second end, said first end of said fluid supply line being attached to said inlet line and said second end being configured for connection to a hot supply line from a water pump to a heater core on a vehicle on which said vehicle-mounted material hopper is carried; and
a heat transfer fluid return line having a first end and a second end, said first end of said fluid return line being attached to said outlet line and said second end being configured for connection to a cold return line from said heater core to said water pump on said vehicle.

2. The radiant heating system of claim 1, wherein said first bottom side section extends away from said inlet line at an angle of greater than 90°.

3. The radiant heating system of claim 1, wherein said second bottom side section extends away from said outlet line at an angle of greater than 90°.

4. The radiant heating system of claim 1, further comprising a first rear section extending between an end of said first bottom side section and an inlet end of said u-shaped section and configured to follow the contour of a first portion of an interior back edge of said vehicle-mounted material hopper.

5. The radiant heating system of claim 4, further comprising a second rear section extending between an end of said second bottom side section and an outlet end of said u-shaped section and configured to follow the contour of a second portion of said interior back edge of said vehicle-mounted material hopper.

6. The radiant heating system of claim 1, further comprising a T-connector attached to said second end of said heat transfer fluid supply line and configured to fluidly connect to said hot supply line.

7. The radiant heating system of claim 1, further comprising a T-connector attached to said second end of said heat transfer fluid return line and configured to fluidly connect to said cold return line.

8. The radiant heating system of claim 1, further comprising at least one fluid control valve between said heat transfer fluid supply line and said radiant heating coil.

9. A vehicle-mounted radiant heating system, comprising:
a material hopper mounted to a vehicle;
a radiant heating coil positioned within an interior of said material hopper, said radiant heating coil comprising an inlet, an outlet, and a flow section between said inlet and said outlet configured to radiate heat to material within said material hopper;
a heat transfer fluid supply line having a first end and a second end, said first end of said fluid supply line being attached to said inlet; and
a heat transfer fluid return line having a first end and a second end, said first end of said return line being attached to said outlet;
wherein said second end of said fluid supply line and said second end of said fluid return line are each attached to and in fluid communication with an engine coolant flow system on said vehicle.

10. The vehicle-mounted radiant heating system of claim 9, said radiant heating coil further comprising an inlet line, an outlet line, a first bottom side section extending away from said inlet line and configured to follow the contour of a first interior side edge of said hopper, a second bottom side section extending away from said outlet line and configured to follow the contour of a second interior side edge of said hopper opposite said first interior side edge, and a u-shaped section fluidly connected to and positioned between said first bottom side section and said second bottom side section and configured to extend into a central recess extending longitudinally along a bottom of said hopper.

11. The radiant heating system of claim 10, wherein said first bottom side section extends away from said inlet line at an angle of greater than 90°.

12. The radiant heating system of claim 10, wherein said second bottom side section extends away from said outlet line at an angle of greater than 90°.

13. The radiant heating system of claim 10, further comprising a first rear section extending between an end of said first bottom side section and an inlet end of said u-shaped section and configured to follow the contour of a first portion of an interior back edge of said hopper.

14. The radiant heating system of claim 13, further comprising a second rear section extending between an end of said second bottom side section and an outlet end of said u-shaped section and configured to follow the contour of a second portion of said interior back edge of said hopper.

15. The vehicle-mounted radiant heating system of claim 9, wherein said second end of said heat transfer fluid supply line is connected to a hot supply line from a water pump to a heater core on said vehicle.

16. The vehicle-mounted radiant heating system of claim 15, further comprising a T-connector fluidly attaching said second end of said heat transfer fluid supply line to said hot supply line.

17. The vehicle-mounted radiant heating system of claim 9, wherein said second end of said heat transfer fluid return line is connected to a cold return line from said heater core to said water pump on said vehicle.

18. The radiant heating system of claim 17, further comprising a T-connector fluidly attaching said second end of said heat transfer fluid return line to said cold return line.

19. The radiant heating system of claim 9, further comprising at least one fluid control valve between said heat transfer fluid supply line and said radiant heating coil.

20. A method for retrofitting a vehicle-mounted material hopper with a radiant heating system, comprising:
providing a radiant heating coil comprising an inlet, an outlet, and a flow section between said inlet and said outlet configured to radiate heat to material within a material hopper mounted on a vehicle;
positioning said radiant heating coil inside of and along a bottom surface of said material hopper;
attaching a first end of a heat transfer fluid supply line to said inlet, and a second end of said heat transfer fluid supply line to an engine coolant flow system on said vehicle; and
attaching a first end of a heat transfer fluid return line to said outlet, and a second end of said heat transfer fluid return line to said engine coolant flow system.

21. The method of claim 20, wherein said radiant heating coil further comprises an inlet line, an outlet line, a first bottom side section extending away from said inlet line and configured to follow the contour of a first interior side edge of said hopper, a second bottom side section extending away from said outlet line and configured to follow the contour of a second interior side edge of said hopper opposite said first interior side edge, and a u-shaped section fluidly connected to and positioned between said first bottom side section and said second bottom side section and configured to extend into a central recess extending longitudinally along a bottom of said hopper.

22. The method of claim 20, wherein said step of attaching a second end of said heat transfer fluid supply line to an engine coolant flow system on said vehicle further comprises connecting said second end of said heat transfer fluid supply line to a hot supply line from a water pump to a heater core on said vehicle.

23. The method of claim 22, further comprising attaching a T-connector to said second end of said heat transfer fluid supply line and to said hot supply line.

24. The method of claim 20, wherein said step of attaching a second end of said heat transfer fluid return line to said engine coolant flow system further comprises connecting said second end of said heat transfer fluid return line to a cold return line from said heater core to said water pump on said vehicle.

25. The method of claim 24, further comprising attaching a T-connector to said second end of said heat transfer return line and to said cold return line.

26. The method of claim 20, further comprising attaching a fluid control valve between said heat transfer fluid supply line and said radiant heating coil.
